(19) United States
(12) Patent Application Publication
(10) Pub. No.: US 2006/0092544 A1
(43) Pub. Date: May 4, 2006

(54) Shock indicator for a data storage tape device

(76) Inventors: Daniel R. Skaar, Denver, CO (US); Stephen Stamm, Ft. Lupton, CO (US); William E. Faulkner, Broomfield, CO (US); Greg Argys, Westminster, CO (US)

Correspondence Address: MORRISON & FOERSTER LLP, 755 PAGE MILL RD, PALO ALTO, CA, 94304-1018, US

(21) Appl. No.: 10/923,347

(22) Filed: Aug. 20, 2004

(51) Int. Cl. G11B 15/12; G11B 19/02; G11B 27/36

(52) U.S. Cl. 360/61; 360/69; 360/31

(57) ABSTRACT

A data storage tape device is provided, including: a housing; a tape medium contained in the housing; and a human-perceivable shock indicator having a default status and a disrupted status, the shock indicator switching from the default status to the disrupted status in response to a shock event such that the disrupted status of the shock indicator is human-perceivable. A method of determining a status of a data storage tape device is provided, including: receiving a data storage tape device comprising a housing, a tape medium contained in the housing, and a human-perceivable shock indicator having a default status and a disrupted status, the shock indicator switching from the default status to the disrupted status in response to a shock event such that the disrupted status of the shock indicator is human-perceivable; and perceiving a status of the shock indicator using an unaided human sense.

### BACKGROUND

Tape drives are widely used for storing information in digital form. These tape drives may be utilized as part of a tape subsystem, which may include a storage subsystem controller for controlling one or more tape drives contained within the storage subsystem and for controlling other components of the storage subsystem, such as the tape picker, which is used to select and load tape cartridges into the tape drives. The storage subsystem may be coupled to a host system b which transmits I/O requests to the storage subsystem via a host/storage connection.

Each tape drive reads and writes data to a tape medium contained within a data storage tape device, which can be, for example, a magnetic tape cartridge 100, shown in FIG. 1. The tape medium typically comprises a thin film of magnetic material which stores the data. The tape medium may be moved by the tape drive between a pair of spaced apart reels and past a data transducer to record or read back information. In one type of tape drive, one of the reels is part of the tape drive while the other reel is part of the removable tape cartridge 100. In another type of tape drive, the data storage tape device is a magnetic tape cassette which contains both reels.

While it may be advantageous for the data storage tape device to be removable and portable, this portability also increases the likelihood that the data storage tape device will experience some sort of shock event caused by mishandling. In some cases, the damage caused by the shock event is undetectable upon a visual inspection of the data storage tape device. For example, dropping a tape cartridge such that the cartridge receives a 45-50 g shock along the reel axis may cause damage to the edge of the tape medium. If the damaged data storage tape device is loaded into a tape drive, the damage may only become apparent when the tape drive is unable to properly read data from the data storage tape device. In addition, merely attempting to load the damaged data storage tape device into the tape drive and read data from the device may exacerbate the damage to the tape medium.

When the damage to the tape device is not perceivable by the human operator, the operator may not be able to diagnose the errors caused when attempting to read or write data to the tape device. Therefore, it can be difficult to diagnose whether the errors are being caused by the tape device or the tape drive. Even when a specialized failure analysis engineer inspects the tape device, the cause of the damage may not be readily apparent.

### BRIEF SUMMARY

In accordance with embodiments of the present invention, a data storage tape device is provided, comprising: a housing; a tape medium contained in the housing; and a human-perceivable shock indicator having a default status and a disrupted status, the shock indicator switching from the default status to the disrupted status in response to a shock event of at least a predetermined threshold such that the disrupted status of the shock indicator is human-perceivable.

In accordance with other embodiments of the present invention, a method of determining a status of a data storage tape device is provided, comprising: receiving a data storage tape device comprising a housing, a tape medium contained in the housing, and a human-perceivable shock indicator having a default status and a disrupted status, the shock indicator switching from the default status to the disrupted status in response to a shock event of at least a predetermined threshold such that the disrupted status of the shock indicator is human-perceivable; and perceiving a status of the shock indicator using an unaided human sense.

In accordance with other embodiments of the present invention, a data storage tape device is provided, comprising: a housing; a tape medium contained in the housing; and a shock indication means for indicating in a human-perceivable fashion a switch from a default status to a disrupted status in response to a shock event of at least a predetermined threshold.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 shows a perspective view of a prior art tape cartridge.

FIGS. 2A-2B show rear views of a shock indicator.

FIG. 3 shows a simplified block diagram of an exemplary shock indicator.

FIG. 4 shows a shock indicator that can provide an audible indication of the indicator state.

FIG. 5 shows another embodiment of a shock indicator that can provide an audible indication of the indicator state.

FIG. 6 shows an exemplary threshold shock curve.

FIGS. 7A-7B show another embodiment of a shock indicator that can provide an audible indication of the indicator state.

FIG. 8 shows a tape drive containing a data storage tape device having a shock indicator.

FIGS. 9A-9C show other embodiments of reflective regions for shock indicators.

FIGS. 10A-10B show other embodiments of dislodgeable bodies.

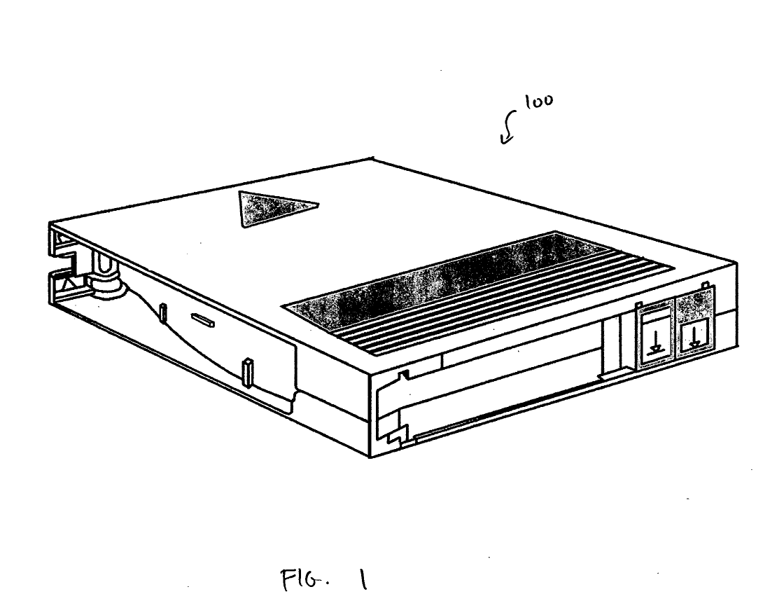

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

In accordance with embodiments of the present invention, a shock indicator may be provided on a data storage tape device to assist users in detecting when the data storage tape device has been subjected to a shock event that is beyond an intended design threshold, thereby posing a risk of data loss. This detection may be performed using only human senses, without the use of a reader mechanism or other detecting device, thereby dramatically increasing the ease and speed with which the shock event can be detected. A human-perceivable indicator is a device that indicates two or more different states in a way that is perceivable by a human without the assistance of amplification, magnification, or other sensing device. In some cases, the human-perceivable indicator may be one that indicates its current state using a visible indicator, such as a color change. In other cases, the human-perceivable indicator may indicate its current state by providing some sort of audible feedback. In other cases, the human-perceivable indicator may indicate its current state by providing some sort of tactile feedback.

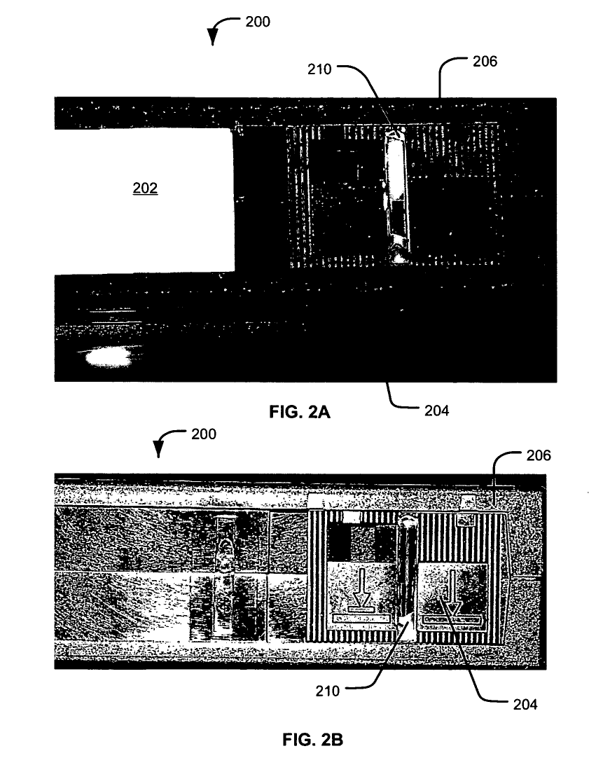

FIGS. 2A-2B show a portion of a data storage tape device incorporating a human-perceivable shock indicator in accordance with embodiments of the present invention. In the embodiment shown in FIGS. 2A-2B, the data storage tape device comprises a tape cartridge 200 including a shock indicator 210. FIG. 2A shows the tape cartridge 200 with the shock indicator 210 in the default state and FIG. 2B shows a plan view of the tape cartridge 200 with the shock indicator in the disrupted state.

The shock indicator 210 is configured to switch from the default state to the disrupted state in response to being subjected to a shock event. In some embodiments, the shock indicator 210 is configured to respond to shock events which occur in a particular direction and of a predetermined magnitude. For example, the shock indicator 210 may be configured to respond to an acceleration or deceleration of at least 45 g along the reel axis (i.e., the axis of rotation of the cartridge reel contained in the tape cartridge 200). If the shock indicator 210 experiences such an acceleration or deceleration, the shock indicator 210 will switch to the disrupted state shown in FIG. 2B.

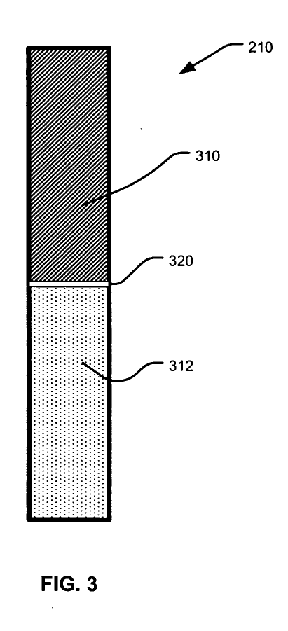

FIG. 3 shows a simplified block diagram of an exemplary shock indicator 210. This shock indicator 210 may include a first region 310 and a second region 312. The first region 310 may be partially filled with a colored liquid, such as a red dye, and the second region 312 may be partially filled with a colorless fluid, such as water. The first region 310 and the second region 312 may be separated by a barrier 320 which is configured to break when the fluid contained in one of the two regions 310 or 312 impacts the barrier 320 with a force corresponding to the predetermined threshold limit of the shock indicator 210. When the barrier 320 breaks, the colored liquid in the first region 310 mixes with the colorless liquid in the second region 312, thereby causing both regions 310 and 312 to be filled with colored liquid. Thus, a user can easily look at the shock indicator 210 to determine the state of the indicator 210 without the use of any special detectors or readers. Similar shock indicators using dye-filled chambers are commercially available and have been used to indicate mishandling of packages during shipping.

In the embodiment shown in FIGS. 2A-2B, the shock indicator 210 is located on the rear side of the tape cartridge 200 and is molded into the write-protector switch 204 on the plastic housing 206 of the cartridge 200. This position for the shock indicator 210 may be desirable because it locates the indicator 210 adjacent to the cartridge label 202, thereby increasing the likelihood that changes in the state of the indicator 210 will be noticed by the user. Typically, when tape cartridges 200 are stacked in a tape library system, the label side of the cartridge faces outward, making the label visible to the user. Thus, with the shock indicator 210 positioned in this location, a user can easily view the shock indicator 210 to determine what state the indicator 210 is in. Another advantage of this location for the shock indicator 210 is that the write-protector switch in existing cartridge designs may be replaced with write-protector switches modified to incorporate a shock indicator 210. This enables the shock indicator 210 to be added to existing cartridge designs without changing the existing mold for the housing 206. In the illustrated embodiment, a small groove in the write-protector switch 204 is provided to receive the indicator 210 and the indicator 210 is overmolded into the switch. In other embodiments, the shock indicator 210 may be located elsewhere on the cartridge 200.

The shock indicator 210 in FIGS. 2A-2B is oriented such that the indicator 210 is sensitive to shock events occurring along the reel axis. This arrangement may be preferable where the tape cartridge is particularly sensitive to shock events in this direction. For example, in tape cartridges conforming to the SDLT standard, shock events in the reel axis direction may cause edge damage to the tape media in the tape cartridge. This is particularly significant as the pitch of the data tracks on the tape media is decreased and the widths of the guard bands along the edges of the tape media are reduced. On the other hand, SDLT-type tape cartridges are relatively resistant to damage caused by shock events occurring in a direction orthogonal to the reel axis. Although these types of shock events may cause the reel to be displaced from the home position, SDLT tape drives are generally configured to be forgiving of offset reels in the tape cartridges. These tape drives may have various algorithms for responding to and correcting misaligned tape reels.

In other embodiments, however, the indicator may be configured to be sensitive to shock events in one or more other directions. For example, a tape cartridge may include a shock indicator 210 oriented in another direction or multiple shock indicators 210 oriented in a plurality of directions, such that the shock events in other directions can cause the shock indicator(s) 210 to change state. This may be preferable when the data storage tape device and/or the tape media is sensitive to damage caused by shock events occurring in directions other than the reel axis. In some embodiments, it may be desirable to have a first shock indicator having a first shock threshold for detecting shock events in a first direction, and a second shock indicator having a second shock threshold higher than the first shock threshold for detecting shock events in a second direction non-parallel with the first direction. Thus, the first shock indicator can be positioned to detect shock events occurring along the reel axis and the second shock indicator can be positioned to detect shock events orthogonal to the reel axis. This second shock indicator may have a significantly higher shock threshold corresponding to the tape cartridge's greater tolerance for shock events orthogonal to the reel axis.

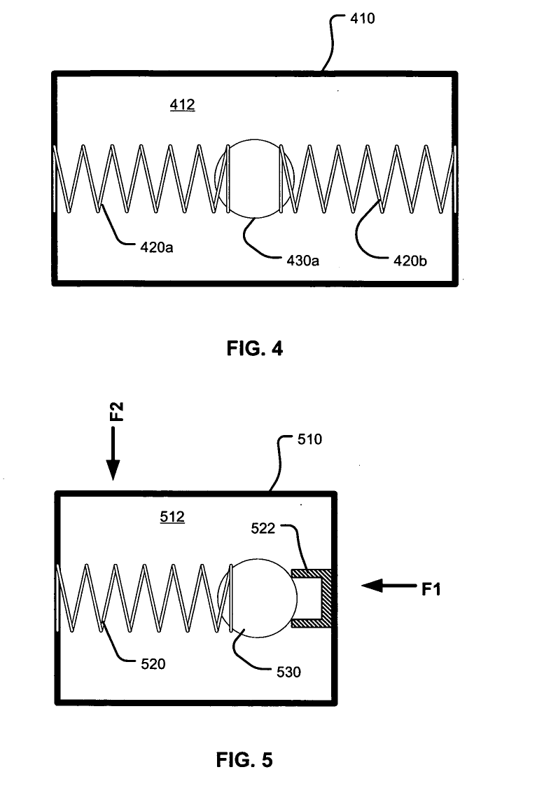

In accordance with other embodiments, a data storage tape device includes a shock indicator that provides a status indication using an audible indicator. This audible indicator can be, for example, a rattling sound caused by a body that is dislodged when the data storage tape device is subjected to a shock event of a predetermined threshold. FIG. 4 shows a shock indicator 410 that can provide a user with a human-perceivable audible indication of the state of the indicator 410. Here, the shock indicator 410 comprises a chamber 412 having a pair of springs 420a-420b supporting a dislodgeable body. In this embodiment, the dislodgeable body comprises a spherical ball bearing 430. The springs 420a-420b may be tuned such that only a shock event of a sufficient amplitude and duration will cause the ball bearing 430 to be released, thereby switching the shock indicator 410 from the default status to the disrupted status. A user can perceive the status of the shock indicator 410 by agitating the tape device. If the ball bearing 430 has been released from the springs 420a-420b, the ball bearing 430 will move about within the chamber 412, causing a rattling sound that is audible to the user. In addition, if the ball bearing 430 has a sufficient mass, the user may be able to tactilely perceive the status change by feeling the impact of the ball bearing 430 against the interior walls of the chamber 412.

The chamber 412 may be sufficiently enclosed such that when the ball bearing 430 is dislodged, the ball bearing 430 cannot exit out of the chamber 412 and interfere with the operation of the data storage tape device or the tape drive in which the tape device is loaded. This chamber 412 may be integrally formed with the housing for the tape device, such as during the molding process, or may be added as a separate component either to the inside or the outside of housing.

FIG. 5 shows a shock indicator 510, similar to the shock indicator 410. In shock indicator 510, however, the ball bearing 530 is supported by a single spring 520 and a support flange 522. The support flange 522 may include a annular support base that is sized to receive and support one side of the ball bearing 530, while the other side of the ball bearing 530 is supported by the compressed spring 520. Similar to the arrangement shown in FIG. 4, the spring 520 may be selected such that the ball bearing 530 will be released when the shock indicator 510 is subjected to a shock event of at least the predetermined threshold.

In these embodiments, if a force F1 is applied to the shock indicator, the ball and spring will react. If the force is of sufficiently high amplitude and duration, the ball bearing will go into resonance with the spring and will be released from the support flange or the other spring. The ball bearing will then be free to rattle about within the chamber. In addition, the shock indicators 410, 510 may be sensitive to forces in the transverse direction, i.e., force F2 perpendicular to the axis of compression of the springs 420, 520. In this case, if the shock indicator experiences a force F2 sufficiently high as to exceed the capture force of the spring(s), then the ball will be released.

In accordance with various embodiments, it may be desirable to use shock indicators that are responsive to different types of shock events. For example, in some cases, it may be desirable to have a shock indicator that will switch from the default status to the disrupted status upon being subjected to a shock event that exceeds a predetermined maximum acceptable acceleration. In other instances, it may be desirable for the shock indicator to be responsive to a combination of both the magnitude and the duration of the acceleration.

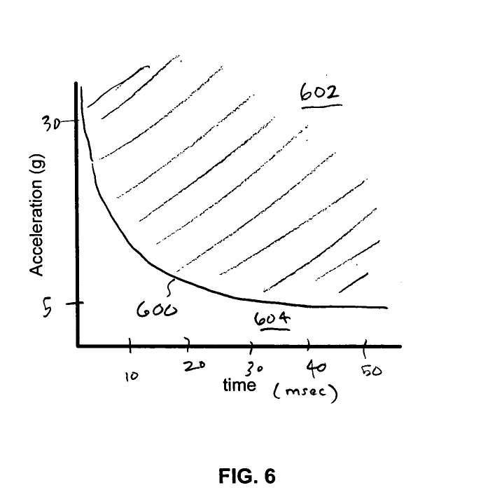

FIG. 6 shows an exemplary threshold curve 600 to which a shock indicator may be configured to be responsive. As can be seen in FIG. 6, a shock event having an acceleration magnitude of greater than 30 g's and duration of at least 10 msecs will cause the shock indicator to switch from the default state to the disrupted state. Shock events having durations of longer than 10 msecs will trigger the shock indicator to change status at lower magnitude accelerations. Depending on the design of the shock indicator, shock events having durations of less than 10 msecs may not result in a change of status for the indicator. However, in no event will the shock indicator change status in response to a shock event having a magnitude of less than 5 g's. The shape of the threshold curve 600 and the values described above are only exemplary. In other embodiments, the shock indicators can be tuned to be responsive to different types of shock events.

In some embodiments, it may be desirable to modify a shock indicator to be responsive to shock events depending on the nature of the tape device. This modification may include changing one or more of the spring tension, the spring constant, and the mass of the dislodgeable body to tune the threshold curve to the desired shape, depending on the design and intended usage of the tape device. For example, if the tape device can withstand larger magnitude shock events, a greater spring tension may be used so that the ball bearing is only dislodged upon subjection to the threshold shock event. The appropriate design for the spring and the dislodgeable body may be obtained using empirical tests to determine the optimal characteristics such that the desired shock threshold limit is provided.

FIGS. 7A-7B show another embodiment of a shock indicator 710. This shock indicator comprises a chamber 712 defined by an enclosure 714 which contains a dislodgeable body 730. The dislodgeable body 730 is retained in its default position by a pair of releasable retaining clips 720a-720b, which mate with one or more grooves or recesses 732 in the body 730. When the shock indicator 710 is subjected to a shock event that exceeds its predetermined shock threshold, the momentum of the body 730 will cause the body 730 to be released from the retaining clips 720a-720b, similar to the way in which the ball bearing 430 is released from the springs 420a-420b, as described above. FIG. 7B shows the shock indicator 710 in the disrupted state such that the body 730 can move freely within the chamber 712. If a user agitates the tape device incorporating the shock indicator 710, the user can determine the state of the shock indicator 710 by listening for the sound of the body 730 rattling against the walls of the enclosure 714.

In accordance with other aspects of the present invention, the shock indicator 710 may be resettable to the default state after having experienced a disrupting shock event. As can be seen in FIGS. 7A-7B, the enclosure 714 may comprise an access opening 716. As described above, after the body 730 has been released by the retaining clips 720a-720b, the body 730 will move freely within the chamber 712. If a user desires to reset the shock indicator 710 into the default state, the user may push the body 730 back into the default position, thereby enabling the spring-loaded retaining clips 720a-720b to reattach to the body 730. To accomplish this, a user may insert a finger or some other object into the access opening 716 in the direction P, as shown in FIG. 7B. A force may be applied to the body 730 to return the body 730 into the default position. In some embodiments, the inner walls of the chamber 712 may be configured to help guide the body 730 back to the default position shown in FIG. 7A when a force is applied through the opening 716.

In other embodiments, a resettable shock indicator 710 may be provided using different configurations. For example, in place of the access opening 716, a button, flange, or other movable member may be provided on the shock indicator 710 in a location accessible by a user. This movable member may be coupled to a resetting member that would contact the body 730 inside the chamber 712. Thus, when a user applies a force onto the button, flange, or other movable member on the outside of the shock indicator 710, the member will transfer this force onto the body 730, causing the body 730 to be pushed back into the default position.

In other embodiments, the resettable shock indicator may be configured such that the shock indicator may be reset by the factory or other trained technician, but not by a casual end user. This may be accomplished, for example, by covering the access opening 716 or by positioning the shock indicator 710 such that the access opening 716 can only be accessed by opening up the cartridge housing. This may help to prevent untrained users from resetting the shock indicator without performing a complete diagnostic check on the cartridge to determine whether any damage has occurred.

In accordance with other aspects of the present invention, the shock indicator 710 may provide an optical indication of the indicator state. As can be seen in FIGS. 7A-7B, the enclosure 714 may further comprise a window 740 (which can be, for example, either an aperture or a sealed translucent window). In addition, the dislodgeable body 730 may comprise a reflective region 740 which is exposed by the window 740 when the dislodgeable body 730 is in the default position, as shown in FIG. 7A. The optical indication may be visible with the unaided eye or may be visible using a detection system, as will be described in greater detail below.

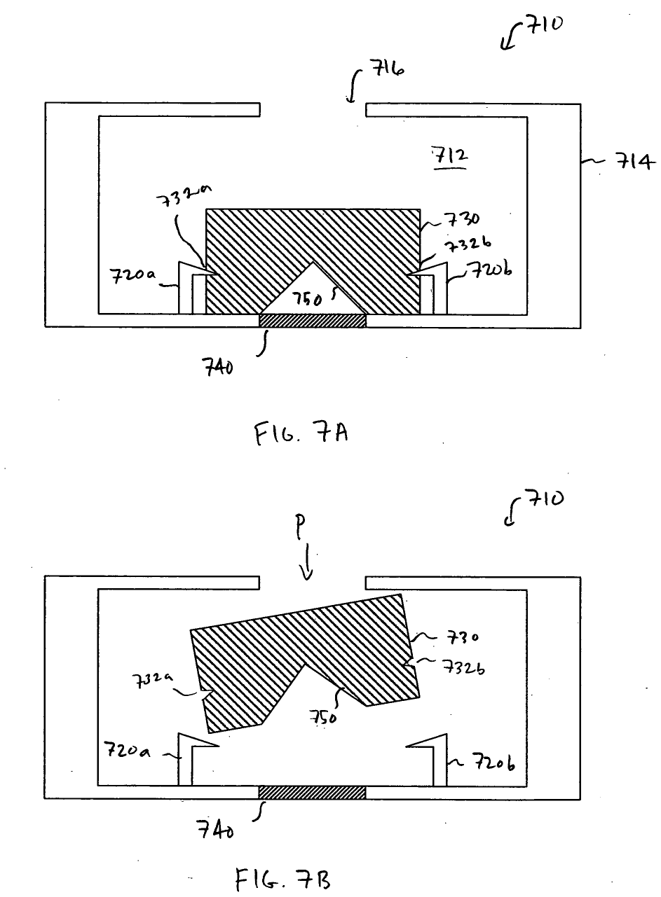

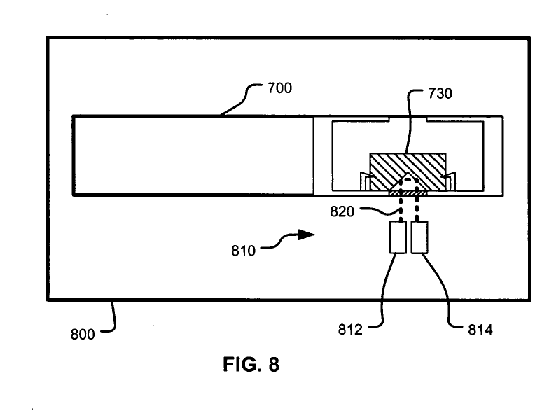

FIG. 8 shows a tape drive 800 in which is a loaded a data storage tape device 700 having a shock indicator 710. The tape drive 800 may comprise an optical detection system 810 which can be used to detect the state of the shock indicator 710. The optical detection system 810 may comprise a transmitter 812 and a receiver 814. The transmitter 812 may emit a beam of light 820 through the window 740 in the shock indicator 710 towards the reflective region 750. If the dislodgeable body 730 is in the default position (as shown in FIGS. 7A and 8), the beam 820 will reflect off of the surface of the reflective region 740 and be detected by the receiver 814. If the appropriate optical signal is detected by the receiver 814, the tape drive 800 can conclude that the shock indicator 710 is in the default state. However, if the shock indicator 710 is in the disrupted state, the dislodgeable body 730 will not be positioned in the default position. Accordingly, the beam 820 will not be reflected back along the expected default path. The tape drive 800 can then conclude that the shock indicator 710 is in the disrupted position.

This arrangement may enable a shock indicator 710 to provide an audible indication of its disrupted state, thereby facilitating rapid detection by the user of potential damage caused by a shock event. In addition, the shock indicator 710 may provide an optical indication of its disrupted state, thereby enabling the tape drive 800 to also detect the state of the shock indicator 710. When the tape drive 800 detects that the shock indicator 710 is in the disrupted state, the tape drive 800 may initiate a process for handling a potentially damaged tape device 700. This process can include one or more of the following steps: immediately ejecting the potentially damaged tape device 700; downloading the data from the potentially damaged tape device 700 prior to ejection; transmitting a message to a user or a host system informing of the potentially damaged tape device 700; and performing diagnostic operations on the tape device to determine whether any damage has occurred.

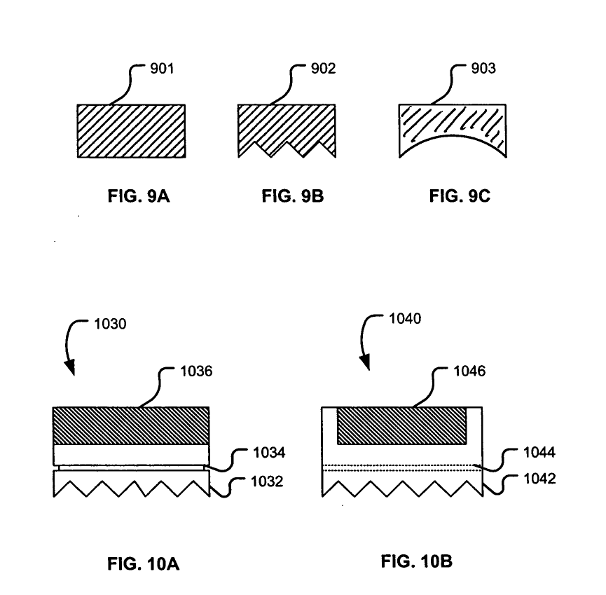

The reflective region 750 of the shock indicator 710 may take various forms. FIGS. 9A-9C show reflective regions 901-903 in accordance with other embodiments. Reflective region 901 comprises a flat reflector, reflective region 902 comprises a multiple corner reflector, and reflective region 903 comprises a parabolic reflector. The multiple corner reflector 902 may be advantageous in that the optical signal need not be as precisely aligned as in the other embodiments in order for the reflection to be detected.

In addition, the dislodgeable body 730 may be formed in different ways. For example, in FIG. 10A, the body 1030 comprises a reflective portion 1032 and a mass portion 1036, which are coupled together to form a single body 1030. An advantage of this arrangement is that the reflective portion 1032 can be manufactured using specialized techniques or materials in order to improve the reflective properties of the reflective portion 1032. The mass portion 1036 can be formed of a more dense and/or less expensive material and attached to the reflective portion 1032 to provide the desired overall mass of the dislodgeable body 1030. This arrangement can also facilitate “tuning” of the shock indicator to be sensitive to varying shock thresholds. For example, in some products, the mass portion 1036 can be made very heavy, thereby increasing the sensitivity of the shock indicator 710. In other products, it may be desired to decrease the sensitivity of the shock indicator 710. This can be accomplished by attaching the reflective portion 1032 to a less heavy mass portion 1036. FIG. 10B shows a similar two-piece arrangement of a reflective portion 1042 and a mass portion 1046. In both embodiments, a groove 1034, 1044 or other recess for mating with the retaining clips 720 may be formed in either the reflective portion 1032, 1042 or the mass portion 1036, 1046.

In accordance with various embodiments, the shock indicator may be positioned in various locations within the tape device. When using a single-reel tape cartridge, it may be desirable to locate the shock indicator in an empty region in one of the corners of the tape cartridge.

The incorporation of human-perceivable shock indicators on data storage tape devices may improve the user's ability to easily identify potentially damaged data storage tape devices. This can be particularly useful, for example, when a user receives a shipment of new data storage tape devices that have been damaged in transit. The human-perceivable shock indicator can quickly indicate to a user prior to insertion into a tape drive whether a data storage tape device has been subjected to an unacceptable shock event and may potentially be damaged.

While the invention has been described in terms of particular embodiments and illustrative figures, those of ordinary skill in the art will recognize that the invention is not limited to the embodiments or figures described. For example, in some of the embodiments described above, the data storage tape device has been described as a tape cartridge. In other embodiments, the data storage tape device can be, for example, a tape cassette or other removable media.

As described above, the shock indicator may be responsive to a shock event of predetermined threshold. This threshold can be, for example, an acceleration of at least 45 g's (wherein 1 g=32 feet/sec²). In other embodiments, the shock threshold may be an acceleration of at least 50 g's, or 60 g's. In yet other embodiments, the shock threshold can be greater or lower.

The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

1. A data storage tape device, comprising:
a housing;
a tape medium contained in the housing; and
a human-perceivable shock indicator having a default status and a disrupted status, the shock indicator switching from the default status to the disrupted status in response to a shock event of at least a predetermined threshold such that the disrupted status of the shock indicator is human-perceivable.

2. The device of claim 1, wherein the shock event is a deceleration of the device at the predetermined threshold.

3. The device of claim 2, wherein the predetermined threshold is at least 1440 feet/sec².

4. The device of claim 2, wherein the predetermined threshold is at least 1600 feet/sec².

5. The device of claim 1, wherein the predetermined threshold corresponds to at least a deceleration threshold at which damage occurs to the tape medium.

6. The device of claim 1, wherein the shock event is a deceleration of the device at a predetermined threshold in one or more predetermined directions.

7. The device of claim 6, further comprising:
a reel about which the tape medium is wound;
wherein one of the predetermined directions corresponds to an axis of rotation of the reel.

8. The device of claim 1, wherein the shock indicator is resettable from the disrupted status to the default status.

9. The device of claim 1, wherein the shock indicator comprises:
a cavity having an interior surface; and
a dislodgeable body in the cavity having a home position corresponding to the default status of the shock indicator and being dislodgeable from the home position in response to the shock event of at least the predetermined threshold such that when the housing is agitated with the shock indicator in the disrupted status, the body will audibly contact the interior surface of the cavity.

10. The device of claim 9, wherein the shock indicator comprises:
one or more springs for retaining the dislodgeable body in the default position until the shock indicator is subjected to a shock event of at least the predetermined threshold.

11. The device of claim 10, wherein the dislodgeable body comprises a spherical ball retained in the default position by the one or more springs, the one or more springs being in a compressed state when retaining the spherical ball.

12. The device of claim 9, wherein the shock indicator comprises:
one or more retaining clips for retaining the dislodgeable body in the home position such that the one or more retaining clips release the dislodgeable body in response to the shock event of at least the predetermined threshold.

13. The device of claim 12, wherein the shock indicator comprises:
an access opening for providing access to the dislodgeable body from outside the shock indicator to reset the dislodgeable body from the disrupted state to the default state.

14. The device of claim 9, wherein the shock indicator comprises:
an enclosure defining the chamber and a window such that the dislodgeable body is optically detectable through the window.

15. The device of claim 1, wherein the shock indicator comprises:
a visible chamber containing a fluid wherein the fluid has a first color corresponding to the default status and a second color different than the first color corresponding to the disrupted status.

16. The device of claim 15, wherein the shock indicator comprises:
a dye containing chamber coupled to the visible chamber such that when the data storage tape device is subjected to a shock event of at least the predetermined threshold, the dye in the dye containing chamber is released into the visible chamber, thereby changing the color of the fluid in the visible chamber from the first color to the second color.

17. The device of claim 16, further comprising:
a breakable wall separating the dye containing chamber from the visible chamber, wherein the breakable wall breaks to in response to the shock event of at least the predetermined threshold thereby releasing the dye in the dye containing chamber into the visible chamber.

18. A method of determining a status of a data storage tape device, comprising:
receiving a data storage tape device comprising a housing, a tape medium contained in the housing, and a human-perceivable shock indicator having a default status and a disrupted status, the shock indicator switching from the default status to the disrupted status in response to a shock event of at least a predetermined threshold such that the disrupted status of the shock indicator is human-perceivable; and
perceiving a status of the shock indicator using an unaided human sense.

19. The method of claim 18, wherein the shock event is a deceleration of the device at the predetermined threshold.

20. The method of claim 18, wherein the predetermined threshold corresponds to at least a deceleration threshold at which damage occurs to the tape medium.

21. The method of claim 18, wherein the shock event is a deceleration of the device at the predetermined threshold in one or more predetermined directions.

22. The method of claim 18, further comprising resetting the shock indicator from the disrupted status to the default status.

23. The method of claim 18, wherein the perceiving the status of the shock indicator using the unaided human sense comprises:
agitating the housing, wherein the shock indicator comprises a cavity having a dislodgeable body provided therein; and
listening for contact of the dislodgeable body against the cavity.

24. The method of claim 18, wherein the perceiving the status of the data storage tape device using the unaided human sense comprises visually perceiving the status of the shock indicator.

25. The method of claim 24, wherein the visually perceiving the status of the shock indicator comprises:
viewing a visible chamber containing a fluid wherein the fluid has a first color corresponding to the default status and a second color different than the first color corresponding to the disrupted status.

26. A data storage tape device, comprising:
a housing;
a tape medium contained in the housing; and
a shock indication means for indicating in a human-perceivable fashion a switch from a default status to a disrupted status in response to a shock event of at least a predetermined threshold.

27. The device of claim 26, wherein the predetermined threshold corresponds to at least a deceleration threshold at which damage occurs to the tape medium.

28. The device of claim 26, wherein the shock event is a deceleration of the device at the predetermined threshold in one or more predetermined directions.

29. The device of claim 26, wherein the shock indication means audibly indicates the switch from the default status to the disrupted status.

30. The device of claim 26, wherein the shock indication means visibly indicates the switch from the default status to the disrupted status.
